(19) United States
(12) Patent Application Publication
(10) Pub. No.: US 2008/0022345 A1
(43) Pub. Date: Jan. 24, 2008

(54) Demodulator and demodulation method

(75) Inventors: Ryan Kim, Yongin-si (KR); Dae-Hwan Kim, Seoul (KR); Jae-Hong Park, Suwon-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/476,834

(22) Filed: Jun. 29, 2006

(51) Int. Cl. H04N 7/173; H04N 7/16

(52) U.S. Cl. 725/131; 725/139

(57) ABSTRACT

A demodulator, for example, a digital video broadcasting-handheld (DVB-H) demodulator may include an erasure table for storing erasure information, a multi-protocol encapsulation forward error correction (MPE-FEC) decoder configured to decode MPE-FEC data within an MPE-FEC frame based on the erasure information, and an erasure table controller configured to generate the erasure information based on a cyclic redundancy check (CRC) operation result regarding transport stream (TS) data to store the generated erasure information into the erasure table and output, to the MPE-FEC decoder, the stored erasure information corresponding to the MPE-FEC data when the MPE-FEC decoder decodes the MPE-FEC data. Therefore, the DVB-H demodulator may process the erasure information faster, for example, independently of a main processor, using the erasure table controller and/or the erasure table.

### BACKGROUND OF THE INVENTION

1. Field of the Invention

Example embodiments of the present invention relate to a demodulator and a demodulating method, and more particularly to a digital video broadcasting-handheld (DVB-H) demodulator and a DVB-H demodulating method capable of processing erasure information faster.

2. Description of the Related Art

Television (TV) is the biggest form of media, and one media that is excluded from most mobile phones. DVB-H is a digital video broadcasting standard for mobile devices and is expected to help convergence mobile devices and TV sets.

FIG. 1 is a conceptual diagram illustrating an example of using a DVB-H system for transmitting Internet media services.

An operation of the Internet media services in FIG. 1 will be described as follows.

A multiplexer 130 may be used to multiplex multi-protocol encapsulation (MPE) data and forward error correction (FEC) data (hereinafter MPE-FEC data) encapsulated by a conventional Moving Picture Experts Group-2 (MPEG-2) TV service 110 and a DVB-H Internet Protocol (IP) encapsulator 120.

A digital video broadcasting-terrestrial (DVB-T) modulator 140 may be used to modulate data output from the multiplexer 130 and transform the modulated data into a radio frequency (RF) signal to transmit the RF signal through a channel 150.

A DVB-H terminal 160 may include a DVB-T demodulator 162 and a DVB-H IP decapsulator 164.

The DVB-T demodulator 162 may be used to demodulate the RF signal to transform the RF signal into a baseband signal. The baseband signal may correspond to an MPEG-2 transport stream (TS).

The DVB-H decapsulator 164 may receive the baseband signal output from the DVB-T demodulator 162 to decapsulate the MPE-FEC data encapsulated by the DVB-H IP encapsulator 120. The DVB-H decapsulator 164 may be used to generate a MPE-FEC frame from the MPE-FEC data.

At least two problems exist with the DVB-H system in FIG. 1.

A first problem relates to power consumption of the DVB-H terminal 160. The DVB-H system may use a time slicing technique to reduce power consumption.

FIG. 2 is a timing diagram illustrating a time slicing operation in the DVB-H system of FIG. 1.

The DVB-H system may operate in a time division manner. A first DVB-H service 210, a second DVB-H service 220, a third DVB-H service 230 and a fourth DVB-H service 240 may be transmitted repeatedly in a sequential manner as illustrated in FIG. 2.

For example, the DVB-H terminal 160 may receive the third DVB-H service 230.

A burst duration 250 indicates a time period during which the DVB-H system transmits the third DVB-H service 230 and an off-time 260 indicates a time period during which the DVB-H system does not transmit the third DVB-H service 230. Additionally, a A-T indicates a time difference between a time point of the third DVB-H service 230 and a time point of a next third DVB-H service 230.

The DVB-H terminal 160 operates in the burst duration 250 and does not operate in the off-time 260. Additionally, the DVB-H terminal 160 knows the A-T, that is, when to operate. Therefore, the power consumption of the DVB-H terminal 160 may be reduced.

A second problem relates to performance in a mobile environment. The DVB-H system may use a MPE-FEC frame to solve the second problem.

FIG. 3 illustrates a structure of a MPE-FEC frame.

The MPE-FEC frame may include, for example, 255 columns divided into two areas: an application data table 310 and a Reed-Solomon (RS) data table 320.

The application data table 310 may be used for storing MPE data and may include, for example, 191 columns and a predetermined number of rows that is variable according to the MPE data. When the application data table 310 is not filled with the MPE data, the application data table 310 is filled with padding data (for example, bit ‘0’).

The RS data table 320 may include, for example, 64 columns and a predetermined number of rows that is variable according to the MPE data. The RS data table 320 may be used for the FEC data and the FEC data is used for preventing deterioration of receiving performance of the DVB-H terminal 160. The FEC data is data for RS coding, and a row of the FEC data corresponds to an RS code for a row of the MPE data.

As illustrated above, the DVB-H terminal 160 enables (i.e., wakes up) the DVB-T demodulator 162 at every A-T for receiving data during the burst duration 250, and decodes the MPE-FEC data in the off-time 260.

When the DVB-H system decodes the MPE-FEC data, the DVB-H system uses a cyclic redundancy check (CRC) code for detecting an MPE-FEC data error. For example, the CRC code indicates reliability of the MPE-FEC data. Erasure information indicates the reliability information of the MPE-FEC data, and using such erasure (reliability) information, the MPE-FEC decoder may correct errors of the MPE-FEC data, up to 64 bytes per 255-byte codeword.

The DVB-H terminal 160 needs to process the erasure information for decoding the MPE-FEC data in a short time. However, when the erasure information is processed using a main processor and a system memory, the processing may cause an increased burden on the main processor, and demands on a system bus bandwidth may increase. As a result, performance of the DVB-H terminal 160 may decrease.

### SUMMARY OF THE INVENTION

Accordingly, example embodiments of the present invention are provided to substantially obviate one or more problems due to limitations and disadvantages of the related art.

Some example embodiments of the present invention provide a digital video broadcasting-handheld (DVB-H) demodulator capable of processing erasure information faster without using a main processor.

Other example embodiments of the present invention provide a DVB-H demodulating method capable of processing erasure information faster without using a main processor.

In some example embodiments of the present invention, a DVB-H demodulator may include an erasure table for storing erasure information, a multi-protocol encapsulation forward error correction (MPE-FEC) decoder configured to decode MPE-FEC data within an MPE-FEC frame based on the erasure information, and/or an erasure table controller configured to generate the erasure information based on a cyclic redundancy check (CRC) operation result regarding transport stream (TS) data to store the generated erasure information into the erasure table, and configured to output, to the MPE-FEC decoder, the stored erasure information corresponding to the MPE-FEC data, when the MPE-FEC decoder decodes the MPE-FEC data. For example, the erasure information may correspond to a logic low when the CRC operation result does not indicate an error, and a logic high when the CRC operation result indicates an error.

The DVB-H demodulator may further include an MPE-FEC flame buffer for storing the MPE-FEC frame, and an MPE-FEC preprocessor configured to perform the CRC operation on the TS data based on CRC data included in the TS data to output the CRC operation result to the erasure table controller, configured to decapsulate the TS data to generate the MPE-FEC data, and configured to store the MPE-FEC data into the MPE-FEC frame buffer to generate the MPE-FEC frame.

The DVB-H demodulator may further include a main processor configured to control the MPE-FEC preprocessor and the MPE-FEC decoder. The reading operation and the storing operation may be processed independently of the main processor.

The DVB-H demodulator may further include a digital video broadcasting-terrestrial (DVB-T) demodulator configured to receive a radio frequency (RF) signal and configured to transform the received RF signal into a baseband signal to output the baseband signal, and a TS selector configured to select the TS data from the baseband signal output from the DVB-T demodulator.

The erasure table controller may store, into the erasure table, the erasure information corresponding to the MPE-FEC data concurrently when the MPE-FEC preprocessor stores the MPE-FEC data into the MPE-FEC frame buffer, and read, from the erasure table, the erasure information corresponding to the MPE-FEC data concurrently when the MPE-FEC decoder reads the MPE-FEC data from the MPE-FEC frame buffer.

The erasure table controller may generate an erasure table address based on an MPE-FEC frame buffer address and stores, into the erasure table, the erasure information at the generated erasure table address when the MPE-FEC preprocessor writes the MPE-FEC data into the MPE-FEC frame buffer, and generate the erasure table address based on the MPE-FEC frame buffer address and reads, from the erasure table, the erasure information at the generated erasure table address when the MPE-FEC decoder reads the MPE-FEC data from the MPE-FEC frame buffer.

The erasure table address may include a row address generated based on a first part (for example, lower 5 bits) of the MPE-FEC frame buffer address and a column address generated based on a second part (for example, upper 13 bits) of the MPE-FEC frame buffer address.

The erasure table controller may include an erasure table access mode detector configured to determine an access mode based on a first chip selection signal that is received from the MPE-FEC preprocessor and a second chip selection signal that is received from the MPE-FEC decoder, and an erasure table address generator configured to generate an erasure table address based on an MPE-FEC buffer address, in which the erasure table controller stores, into the erasure table, the erasure information at the generated erasure table address when the erasure table access mode detector determines the access mode as a writing mode, and reads, from the erasure table, the erasure information at the generated erasure table address when the erasure table access mode detector determines the access mode as a reading mode.

The erasure table address may include a row address generated based on a first part (for example, lower 5 bits) of the MPE-FEC frame buffer address and a column address generated based on a second part (for example, upper 13 bits) of the MPE-FEC frame buffer address.

In other example embodiments of the present invention, a DVB-H demodulating method may include generating erasure information based on a CRC operation result regarding TS data, decapsulating the TS data to generate MPE-FEC data, storing the generated erasure information into an erasure table, generating an MPE-FEC frame with the MPE-FEC data to store the MPE-FEC frame into an MPE-FEC frame buffer; reading the MPE-FEC data within the MPE-FEC frame and the erasure information, and/or decoding the MPE-FEC data based on the erasure information.

Storing the generated erasure information and generating the MPE-FEC frame may be performed concurrently. For example, the erasure information may correspond to a logic low when the CRC operation result does not indicate an error, and a logic high when the CRC operation result indicates an error.

Storing the generated erasure information includes generating an erasure table address based on an MPE-FEC frame buffer address when the MPE-FEC data is stored into the MPE-FEC frame buffer, and storing, into the erasure table, the erasure information at the erasure table address. The erasure table address may include a row address generated based on a first part (for example, lower 5 bits) of the MPE-FEC frame buffer address and a column address generated based on a second part (for example, upper 13 bits) of the MPE-FEC frame buffer address.

Decoding the MPE-FEC data may include generating an erasure table address based on an MPE-FEC frame buffer address when the MPE-FEC data is read from the MPE-FEC frame buffer, and reading, from the erasure table, the erasure information at the erasure table address. The erasure table address may include a row address generated based on a first part (for example, lower 5 bits) of the MPE-FEC frame buffer address and a column address generated based on a second part (for example, upper 13 bits) of the MPE-FEC frame buffer address.

Therefore, example embodiment of a demodulator and demodulating method may process erasure information faster by using an erasure table controller and/or an erasure table.

### BRIEF DESCRIPTION OF THE DRAWINGS

Example embodiments of the present invention will become more apparent by describing in detail example embodiments of the present invention with reference to the accompanying drawings, wherein:

FIG. 1 is a conceptual diagram illustrating an example of using a digital video broadcasting-handheld (DVB-H) system for transmitting Internet media services;

FIG. 2 is a timing diagram illustrating a time slicing operation in the DVB-H system of FIG. 1;

FIG. 3 illustrates a structure of a multi-protocol encapsulation forward error correction (MPE-FEC) frame;

FIG. 4 is a block diagram illustrating a DVB-H demodulator according to an example embodiment of the present invention;

FIG. 5 is a block diagram illustrating an example embodiment of an MPE-FEC decoding unit in FIG. 4;

FIG. 6 is a block diagram illustrating an example embodiment of an erasure table controller in FIG. 5; and

FIGS. 7A and 7B illustrate a process in which an MPE-FEC preprocessor reads/writes MPE-FEC data, from/into an MPE-FEC frame buffer, respectively and erasure information corresponding to the MPE-FEC data from/into the erasure table.

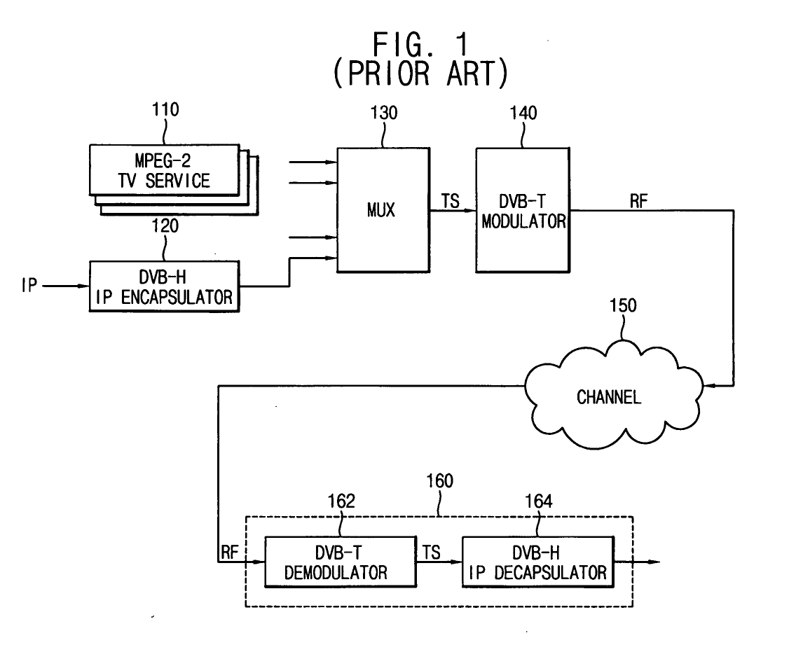

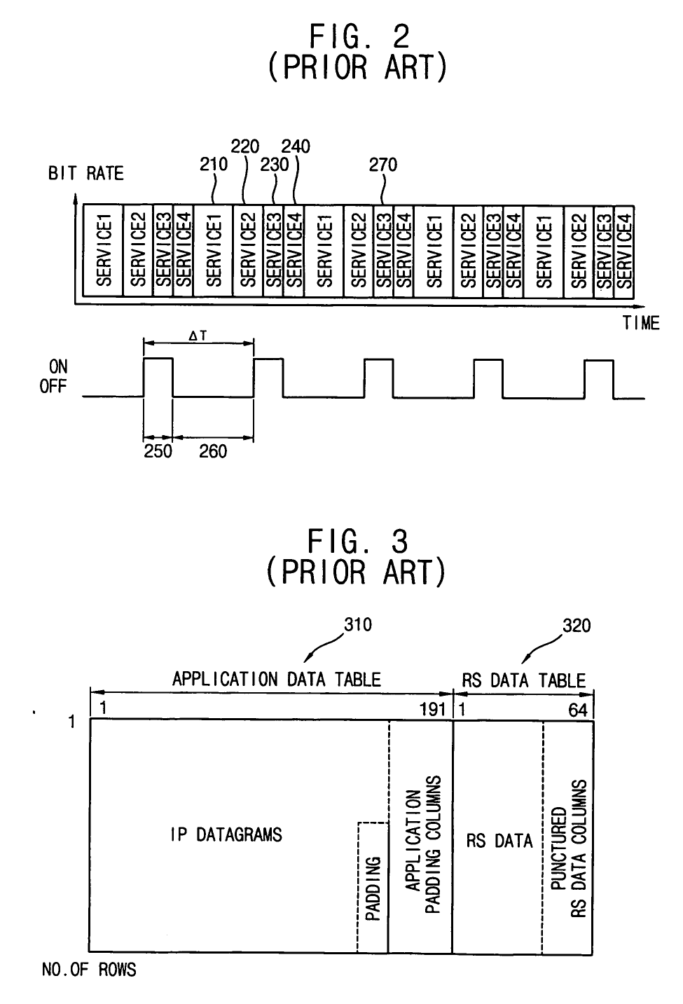

### DESCRIPTION OF EXAMPLE EMBODIMENTS

Detailed illustrative example embodiments of the present invention are disclosed herein. However, specific structural and functional details disclosed herein are merely representative for purposes of describing example embodiments of the present invention. This invention may, however, be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms fist, second, etc. may be used herein to describe various elements, these elements should not be limited by these terms. These terms are used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present invention now will be described more fully hereinafter with reference to the accompanying figures, in which embodiments of the invention are shown. However, it should be understood that there is no intent to limit the invention to the particular forms disclosed, but on the contrary, the invention is to cover all modifications, equivalents, and alternatives falling within the spirit and scope of the invention as defined by the claims.

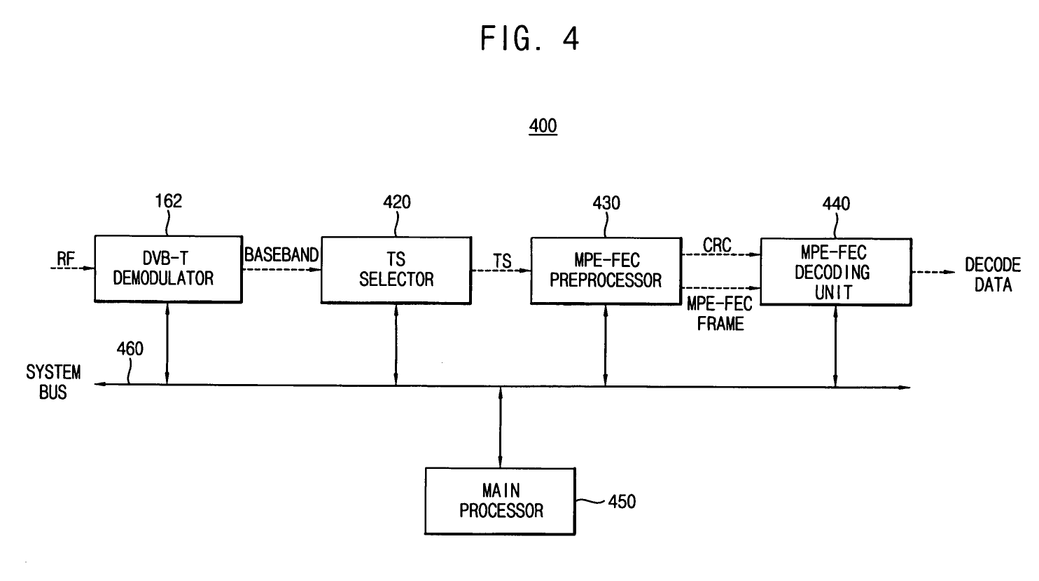

FIG. 4 is a block diagram illustrating a digital video broadcasting-handheld (DVB-H) demodulator according to an example embodiment of the present invention.

Referring to FIG. 4, a DVB-H demodulator 400 may include the digital video broadcasting-terrestrial (DVB-T) demodulator 162, a transport stream (TS) selector 420, a multi-protocol encapsulation and forward error correction (MPE-FEC) preprocessor 430, an MPE-FEC decoding unit 440, a main processor 450 and/or a system bus 460.

The DVB-T demodulator 162 may demodulate a radio frequency (RF) signal to transform the RF signal into a baseband signal. The baseband signal may correspond to a Moving Picture Experts Group-2 (MPEG-2) TS.

The TS selector 420 may select user-determined TS data among the TS data output from the DVB-T demodulator 162. That is, the baseband signal output from the DVB-T demodulator 162 may include TS data of various media channels, and the TS selector 420 may be used to select a specific media channel data requested by a user.

The MPE-FEC preprocessor 430 may decapsulate the TS data output from the TS selector 420 to output MPE-FEC data, and performs a cyclic redundancy check (CRC) operation to output a CRC result, that is, information about whether the TS data has an error or not.

The MPE-FEC decoding unit 440 generates erasure information based on the CRC operation result and an MPE-FEC frame based on the MPE-FEC data The MPE-FEC decoding unit 440 decodes the MPE-FEC frame based on the erasure information. An operation of the MPE-FEC decoding unit 440 will be described below.

The main processor 450 may be a central processing unit (CPU) for controlling entire operation of the DVB-H demodulator 400. For example, the main processor 450 may control a transmission of the TS data, when the TS data is transmitted from the DVB-T demodulator 162 to the TS selector 420.

The system bus 460 may be a channel for transmitting data among the DVB-T demodulator 162, the TS selector 420, the MPE-FEC preprocessor 430, the MPE-FEC decoding unit 440 and/or the main processor 460. For example, when the TS data is transmitted from the DVB-T demodulator 162 to the TS selector 420, the TS data may be transmitted through the system bus 460.

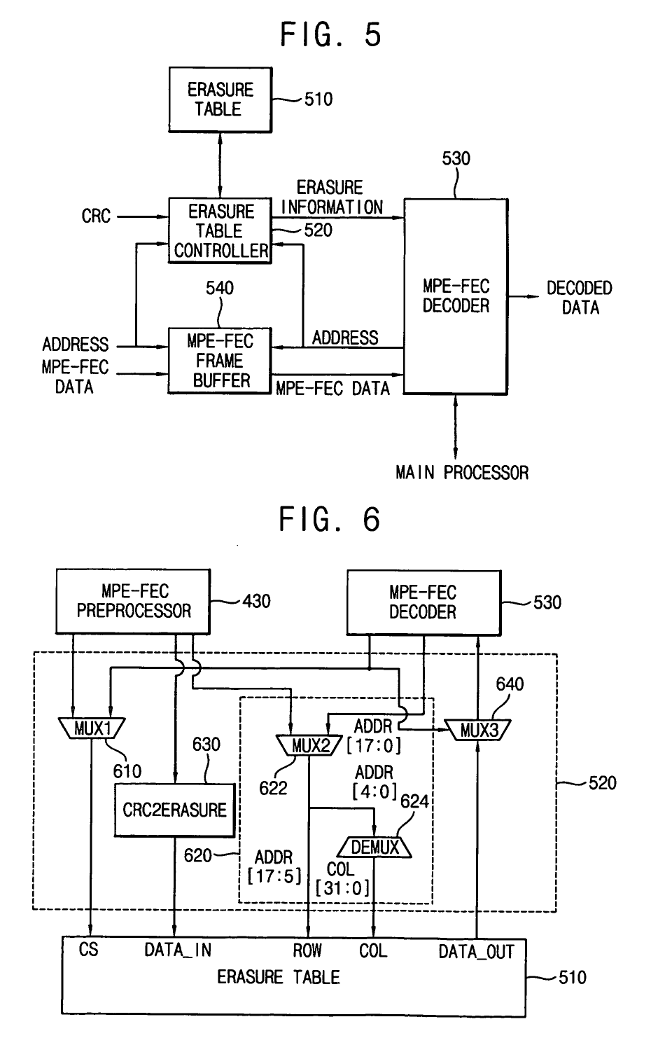

FIG. 5 is a block diagram illustrating an example embodiment of the MPE-FEC decoding unit in FIG. 4.

Referring to FIG. 5, the MPE-FEC decoding unit 440 may include an erasure table 510, an erasure table controller 520 and/or an MPE-FEC decoder 530. In addition, the MPE-FEC decoding unit 440 may also include an MPE-FEC frame buffer 540.

The erasure table 510 may be a memory device for storing the erasure information. The erasure information may be generated based on a result of CRC operation of the MPE-FEC preprocessor 430 of FIG. 4, and may indicate whether the MPE-FEC data has an error or not.

The erasure table controller 520 may receive the CRC operation result of the MPE-FEC data to generate the erasure information based on the CRC operation result. In addition, when the MPE-FEC data is stored in the MPE-FEC frame buffer 540, the erasure table controller 520 receives an MPE-FEC frame buffer address to generate an erasure table address based on the MPE-FEC frame buffer address. The erasure table controller 520 may store, into the erasure table, the erasure information at the generated erasure table address corresponding to the MPE-FEC frame buffer address.

When the MPE-FEC decoder 530 reads the MPE-FEC data, the erasure table controller 520 may receive the MPE-FEC frame buffer address corresponding to the MPE-FEC data, and generate the erasure table address based on the MPE-FEC frame buffer address. The erasure table controller 520 may output the erasure information that is stored in the erasure table 510.

As illustrated above, the erasure table controller 520 may write and read the erasure information independently of the main processor 450. An operation of the erasure table controller 520 will be described later.

The MPE-FEC frame buffer 540 may store the MPE-FEC data output from the MPE-FEC preprocessor 430 and the stored MPE-FEC data corresponding to the MPE-FEC frame. The MPE-FEC frame buffer 540 may be included in the MPE-FEC decoding unit 440 or may be implemented as a separate external to the MPE-FEC decoding unit 440.

The MPE-FEC decoder 530 may read, from the MPE-FEC frame buffer 540, the MPE-FEC data within the MPE-FEC frame at a desired or predetermined MPE-FEC frame buffer address and the erasure information at the erasure table address corresponding to the desired or predetermined MPE-FEC frame buffer address. The MPE-FEC decoder 530 may decode the MPE-FEC data based on the read erasure information.

Hereinafter, example operation of the MPE-FEC decoding unit 440 will be described.

A process in which the erasure table controller 520 stores the erasure information into the erasure table 510 is described as follows.

The MPE-FEC preprocessor 430 may decapsulate the TS data to generate the MPE-FEC data, and store, into the MPE-FEC frame buffer 540, the generated MPE-FEC data at a desired or predetermined MPE-FEC frame buffer address. The MPE-FEC data stored in the MPE-FEC frame buffer 540 may form the MPE-FEC frame. The desired or predetermined MPE-FEC frame buffer address may be generated by the main processor 450 or the MPE-FEC preprocessor 430. The MPE-FEC preprocessor 430 may perform a CRC operation on the MPE-FEC data to output the CRC operation result.

The erasure table controller 520 may receive the MPE-FEC data output from the MPE-FEC preprocessor 430 and generate the erasure information corresponding to the MPE-FEC data. The erasure information may be, for example, a logic low (i.e., bit ‘0’) when the CRC operation result does not indicate an error and a logic high (i.e., bit ‘1’) when the CRC operation result indicates an error. In addition, the erasure table controller 520 may receive the MPE-FEC frame buffer address and generate the erasure table address corresponding to the MPE-FEC frame buffer address.

The erasure table controller 520 may store, into the erasure table 510, the erasure information at the erasure table address corresponding to the MPE-FEC frame buffer address.

A process in which the erasure table controller 520 outputs the erasure information from the erasure table 510 is described as follows.

The MPE-FEC decoder 530 may read, from the MPE-FEC frame buffer 540, the MPE-FEC data at a desired or predetermined MPE-FEC frame buffer address. For example, the desired or predetermined MPE-FEC frame buffer address may be generated by the main processor 450 or the MPE-FEC decoder 530.

The erasure table controller 520 may receive the MPE-FEC frame buffer address and generate the erasure table address based on the MPE-FEC frame buffer address. The erasure table controller 520 may read, from the erasure table 510, the erasure information at the erasure table address and output the erasure information to the MPE-FEC decoder 530.

FIG. 6 is a block diagram illustrating an example embodiment of the erasure table controller 520 in FIG. 5.

Referring to FIG. 6, the erasure table controller 520 may include an erasure table access mode detector 610, an erasure table address generator 620, an erasure information generator 630, and/or an erasure information output unit 640.

The erasure table access mode detector 610 may receive a chip select signal from the MPE-FEC preprocessor 430 or the MPE-FEC decoder 530, and detects an access mode: a reading mode for reading from the erasure table 510 or a writing mode for writing into the erasure table 510. For example, when the erasure table access mode detector 610 receives the chip select signal output from the MPE-FEC preprocessor 430, the erasure table access mode detector 610 may determine the access mode as the reading mode, and when the erasure table access mode detector receives the chip select signal output from the MPE-FEC decoder 530, the erasure table access mode detector 610 may determine the access mode as the writing mode.

The erasure table address generator 620 may receive the MPE-FEC frame buffer address from the MPE-FEC preprocessor 430 or the MPE-FEC decoder 530 and generate the erasure table address based on the MPE-FEC frame buffer address. When the erasure table 510 may be configured with, for example, 8,192 rows and 32 columns, and the MPE-FEC frame buffer address may be configured with 18 bits such that first 13 bits of the MPE-FEC frame buffer address indicate a row address of the erasure table 510 and second 5 bits of the MPE-FEC frame buffer address indicate a column address of the erasure table 510. The first 13 bits of the MPE-FEC frame buffer address may correspond to upper 13 bits of the MPE-FEC frame buffer address and the second 5 bits of the MPE-FEC frame buffer address may correspond to lower 5 bits of the MPE-FEC frame buffer address.

The erasure information generator 630 may receive a CRC operation result regarding the MPE-FEC data output from the MPE-FEC preprocessor 430 and generate the erasure information corresponding to the CRC operation result. The erasure information may be, for example, a logic low (i.e., bit ‘0’) when the CRC operation result does not indicate an error and may be a logic high (i.e., bit ‘1’) when the CRC operation result indicates an error.

The erasure information output unit 640 may output the erasure information at the erasure table address to the MPE-FEC decoder 530, when the erasure table access mode detector 610 determines the access mode as the reading mode.

Hereinafter, example operation of the erasure table controller 520 will be described.

A process in which the erasure table controller 520 stores the erasure information into the erasure table 510 is described as follows.

The erasure table access mode detector 610 may receive the chip select signal from the MPE-FEC preprocessor 430 and determine the access mode of the erasure table 510 as the writing mode. When the access mode of the erasure table 510 corresponds to the writing mode, the erasure table access mode detector 610 may output, for example, a logic low (i.e., bit ‘0’). The erasure table address generator 620 may generate row and column addresses of the erasure table 510 based on the MPE-FEC frame buffer address (e.g., 18-bit address) output from the MPE-FEC preprocessor 430.

The erasure information generator 630 may receive the CRC operation result regarding the MPE-FEC data output from the MPE-FEC preprocessor 430, and generate the erasure information to output the erasure information corresponding to the CRC operation result.

The erasure table 510 may receive the chip select signal CS, a row address ROW, a column address COL and the erasure information DATA_IN, and store the erasure information at the erasure table address corresponding to a row and a column of the erasure table 510.

A process in which the erasure table controller 520 reads the erasure information from the erasure table 510 is described as follows.

The erasure table access mode detector 610 may receive the chip selection signal CS from the MPE-FEC decoder 530, and determine the access mode of the erasure table 510 as the reading mode. When the access mode of the erasure table 510 corresponds to the reading mode, the erasure table access mode detector 610 may output, for example, a logic high (i.e., bit ‘1’). The erasure table address generator 620 may generate row and column addresses of the erasure table 510 based on the MPE-FEC frame buffer address (e.g., 18-bit address) output from the MPE-FEC decoder 430.

The erasure table 510 may receive the chip selection signal CS, the row address ROW and the column address COL, and outputs the erasure information at the row and the column of the erasure table 510 corresponding to the 18-bit erasure table address.

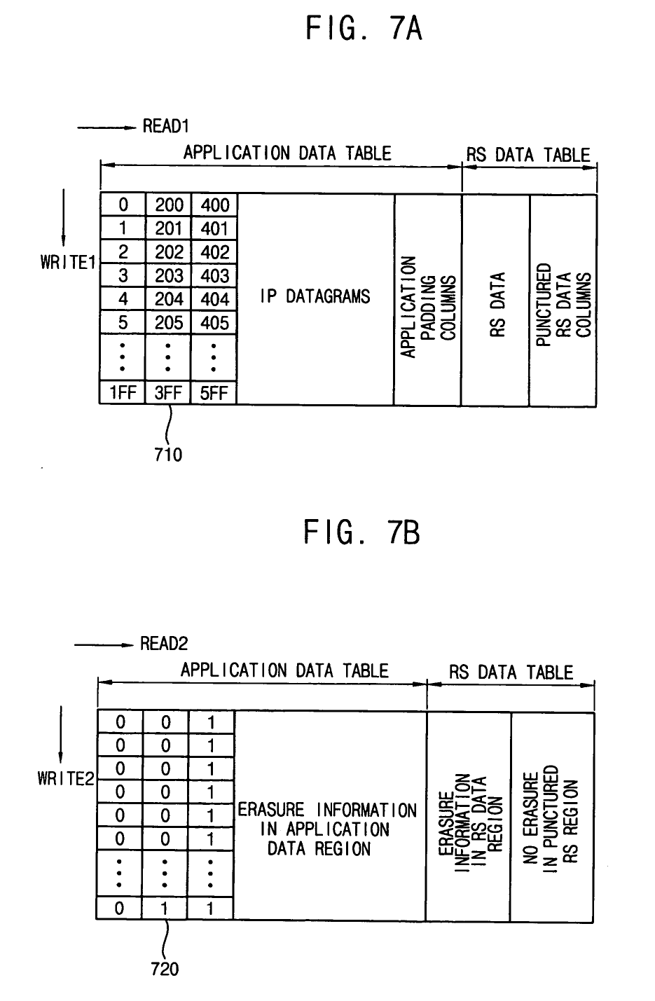

FIGS. 7A and 7B illustrate a process in which an MPE-FEC preprocessor, for example, MPE-FEC preprocessor 430, reads/writes MPE-FEC data, from/into an MPE-FEC frame buffer respectively and erasure information corresponding to the MPE-FEC data from/into the erasure table.

A process in which the MPE-FEC preprocessor 430 writes the MPE-FEC data into the MPE-FEC frame buffer 540 and the erasure information corresponding to the MPE-FEC data into the erasure table 510 will be described as follows.

The MPE-FEC preprocessor 430 may decapsulate the TS data to generate the MPE-FEC data and store, into the MPE-FEC frame buffer 540, the MPE-FEC data at the MPE-FEC frame buffer address in a row direction (a WRITE1 direction of FIG. 7A). The MPE-FEC data stored in the MPE-FEC frame buffer 540 may form the MPE-FEC frame. Concurrently, the erasure table controller 520 may generate the erasure table address corresponding to the MPE-FEC frame buffer address and store, into the erasure table 510, the erasure information at the erasure table address in a row direction (a WRITE2 direction of FIG. 7B).

For example, if a number of rows in a MPE-FEC frame 710 corresponds to 255, the MPE-FEC preprocessor 430 may sequentially store the MPE-FEC data from a 0th row of a 0th column to a 1FFth row of the 0th column and then from a 0th row of a first column to a 1FFth row of the first column.

Concurrently, the erasure table controller 520 may generate the erasure table address corresponding to the MPE-FEC frame buffer address, and sequentially stores the erasure information at the erasure table address.

A process in which the MPE-FEC preprocessor 430 reads the MPE-FEC data from the MPE-FEC frame buffer 540 and the erasure information corresponding to the MPE-FEC data from the erasure table 510 will be described as follows.

The MPE-FEC decoder 530 may read, from the MPE-FEC frame buffer 540, the MPE-FEC data of the MPE-FEC frame 710 in a column direction (a READ1 direction of FIG. 7A) so as to decode the MPE-FEC data Concurrently, the erasure table controller 520 may generate the erasure table address based on the MPE-FEC frame buffer address to read, from the erasure table 510, the erasure information at the erasure table address in a column direction (a READ2 direction of FIG. 7B).

For example, if the column number of the MPE-FEC frame 710 corresponds to 255, the MPE-FEC preprocessor 430 may sequentially read the MPE-FEC data from a 0th column of a 0th row to the 255th column of the 0th row and then from a 0th column of a first row to a 255th column of the first row.

Concurrently, the erasure table controller 520 may generate the erasure table address corresponding to the MPE-FEC frame buffer address, and sequentially reads the erasure information at the erasure table address.

As described above, a DVB-H demodulator according to an example embodiment of the present invention may read and write the erasure information, independently of the main processor, by using an erasure table controller and/or an erasure table.

In addition, a DVB-H demodulator according to an example embodiment of the present invention may process the erasure information faster by using the erasure table controller and/or the erasure table.

Example embodiments of the present invention being thus described, it will be obvious that the same may be varied in many ways. For example, it is understood that the above-described MPE-FEC decoding unit may be configured with a single chip and additionally the respective functional unit (i.e., the erasure table, the erasure table controller and the MPE-FEC decoder) may be configured with a separate chip. Additionally, the erasure table may be implemented within the MPE-FEC decoding unit, but may be configured with a separate memory coupled to the main processor.

Such variations are not to be regarded as a departure from the spirit and scope of example embodiments of the present invention, and all such modifications as would be obvious to one skilled in the art are intended to be included within the scope of the following claims.

What is claimed is:

1. A digital video broadcasting-handheld (DVB-H) demodulator, comprising:
an erasure table for storing erasure information;
a multi-protocol encapsulation forward error correction (MPE-FEC) decoder configured to decode MPE-FEC data within an MPE-FEC frame based on the erasure information; and
an erasure table controller configured to generate the erasure information based on a cyclic redundancy check (CRC) operation result regarding transport stream (TS) data to store the generated erasure information into the erasure table, and configured to output, to the MPE-FEC decoder, the stored erasure information corresponding to the MPE-FEC data when the MPE-FEC decoder decodes the MPE-FEC data.

2. The DVB-H demodulator of claim 1, wherein the erasure information corresponds to a logic low when the CRC operation result does not indicate an error, and a logic high when the CRC operation result indicates an error.

3. The DVB-H demodulator of claim 1, further comprising:
an MPE-FEC frame buffer for storing the MPE-FEC frame; and
an MPE-FEC preprocessor configured to perform the CRC operation on the TS data based on CRC data included in the TS data to output the CRC operation result to the erasure table controller, configured to decapsulate the TS data to generate the MPE-FEC data, and configured to store the MPE-FEC data into the MPE-FEC frame buffer to generate the MPE-FEC frame.

4. The DVB-H demodulator of claim 3, wherein the erasure table controller:
is configured to store, into the erasure table, the erasure information corresponding to the MPE-FEC data, concurrently when the MPE-FEC preprocessor stores the MPE-FEC data into the MPE-FEC frame buffer, and
is configured to read, from the erasure table, the erasure information corresponding to the MPE-FEC data, concurrently when the MPE-FEC decoder reads the MPE-FEC data from the MPE-FEC frame buffer.

5. The DVB-H demodulator of claim 3, further comprising:
a main processor configured to control the MPE-FEC preprocessor and the MPE-FEC decoder.

6. The DVB-H demodulator of claim 5, wherein the reading operation and the storing operation are performed independently of the main processor.

7. The DVB-H demodulator of claim 3, further comprising:
a digital video broadcasting-terrestrial (DVB-T) demodulator configured to receive an radio frequency (RF) signal, and configured to transform the received RF signal into a baseband signal to output the baseband signal; and
a TS selector configured to select the TS data from the baseband signal output from the DVB-T demodulator.

8. The DVB-H demodulator of claim 3, wherein the erasure table controller:
is configured to generate an erasure table address based on an MPE-FEC frame buffer address and store, into the erasure table, the erasure information at the generated erasure table address when the MPE-FEC preprocessor writes the MPE-FEC data into the MPE-FEC frame buffer, and
is configured to generate the erasure table address based on the MPE-FEC frame buffer address and read, from the erasure table, the erasure information at the generated erasure table address when the MPE-FEC decoder reads the MPE-FEC data from the MPE-FEC frame buffer.

9. The DVB-H demodulator of claim 8, wherein the erasure table address includes a row address generated based on a first part of the MPE-FEC frame buffer address and a column address generated based on a second part of the MPE-FEC frame buffer address.

10. The DVB-H demodulator of claim 9, wherein the first part corresponds to lower 5 bits of the MPE-FEC frame buffer address and the second part corresponds to upper 13 bits of the MPE-FEC frame buffer address.

11. The DVB-H demodulator of claim 3, wherein the erasure table controller comprises:
an erasure table access mode detector configured to determine an access mode based on a first chip selection signal received from the MPE-FEC preprocessor and a second chip selection signal received from the MPE-FEC decoder; and
an erasure table address generator configured to generate an erasure table address based on an MPE-FEC buffer address,
wherein the erasure table controller is configured to store, into the erasure table, the erasure information at the generated erasure table address when the erasure table access mode detector determines the access mode as a writing mode, and is configured to read, from the erasure table, the erasure information at the generated erasure table address when the erasure table access mode detector determines the access mode as a reading mode.

12. The DVB-H demodulator of claim 11, wherein the erasure table address includes a row address generated based on a first part of the MPE-FEC frame buffer address and a column address generated based on a second part of the MPE-FEC frame buffer address.

13. The DVB-H demodulator of claim 12, wherein the first part corresponds to lower 5 bits of the MPE-FEC frame buffer address and the second part corresponds to upper 13 bits of the MPE-FEC frame buffer address.

14. A DVB-H demodulating method, comprising:
generating erasure information based on a CRC operation result regarding TS data;
storing the generated erasure information into an erasure table;
reading MPE-FEC data within an MPE-FEC frame buffer and the erasure information corresponding to the MPE-FEC data; and
decoding the MPE-FEC data based on the erasure information.

15. The method of claim 14, further comprising:
decapsulating the TS data to generate the MPE-FEC data; and
storing the MPE-FEC data into an MPE-FEC frame buffer to generate an MPE-FEC frame;

16. The method of claim 15, wherein storing the generated erasure information and generating the MPE-FEC frame are performed concurrently.

17. The method of claim 15, wherein the erasure information corresponds to a logic low when the CRC operation result does not indicate an error, and a logic high when the CRC operation result indicates an error.

18. The method of claim 15, wherein storing the generated erasure information comprises:
generating an erasure table address based on an MPE-FEC frame buffer address when the MPE-FEC data is stored into the MPE-FEC frame buffer; and
storing, into the erasure table, the erasure information at the erasure table address.

19. The method of claim 18, wherein the erasure table address includes a row address generated based on a first part of the MPE-FEC frame buffer address and a column address generated based on a second part of the MPE-FEC frame buffer address.

20. The method of claim 19, wherein the first part corresponds to lower 5 bits of the MPE-FEC frame buffer address and the second part corresponds to upper 13 bits of the MPE-FEC frame buffer address.

21. The method of claim 15, wherein decoding the MPE-FEC data comprises:
generating an erasure table address based on an MPE-FEC frame buffer address when the MPE-FEC data is read from the MPE-FEC frame buffer, and
reading, from the erasure table, the erasure information at the erasure table address.

22. The method of claim 21, wherein the erasure table address includes a row address generated based on a first part of the MPE-FEC frame buffer address and a column address generated based on a second part of the MPE-FEC frame buffer address.

23. The method of claim 22, wherein the first part corresponds to lower 5 bits of the MPE-FEC frame buffer address and the second part corresponds to upper 13 bits of the MPE-FEC frame buffer address.

24. A demodulator, comprising:
an erasure table for storing erasure information;
a main processor; and
an erasure table controller configured to generate the erasure information and configured to output, to a decoder, the stored erasure information corresponding to data when the decoder decodes the data, independent of the main processor.

25. A demodulating method, comprising:
generating erasure information;
storing the generated erasure information into an erasure table;
reading data within a frame buffer and the erasure information corresponding to the data;
controlling transmission of the data with a main processor; and
decoding the data based on the erasure information, independent of the main processor.

26. An erasure table controller comprising:
an erasure table access mode detector configured to determine an access mode based on a first chip selection signal received from an MPE-FEC preprocessor and a second chip selection signal received from an MPE-FEC decoder; and
an erasure table address generator configured to generate an erasure table address based on an MPE-FEC buffer address,
wherein the erasure table controller is configured to store, into an erasure table, the erasure information at the generated erasure table address when the erasure table access mode detector determines the access mode as a writing mode, and is configured to read, from the erasure table, the erasure information at the generated erasure table address when the erasure table access mode detector determines the access mode as a reading mode.

27. A method of reading and writing erasure information, comprising:
determining an access mode based on a first chip selection signal received from an MPE-FEC preprocessor and a second chip selection signal received from an MPE-FEC decoder; and
generating an erasure table address based on an MPE-FEC buffer address,
storing, into an erasure table, the erasure information at the generated erasure table address when the access mode is determined to be a writing mode, and
reading, from the erasure table, the erasure information at the generated erasure table address when the access mode is determined to be a reading mode.
